(19) United States
(12) Patent Application Publication
(10) Pub. No.: US 2019/0146581 A1
(43) Pub. Date: May 16, 2019

(54) GLOVE FOR GESTURE IDENTIFICATION

(71) Applicant: Cheng Uei Precision Industry Co., Ltd., New Taipei City (TW)

(72) Inventors: Duo Chi Fan, New Taipei City (TW); Sheng Yuan Lin, New Taipei City (TW)

(21) Appl. No.: 16/145,214

(22) Filed: Sep. 28, 2018

(30) Foreign Application Priority Data
Nov. 15, 2017 (CN) 201711128869.4

(51) Int. Cl. G06F 3/01; A41D 19/00; A41D 27/00

(52) U.S. Cl. CPC G06F 3/014; G06F 3/017; A41D 27/00; A41D 19/00

(57) ABSTRACT

A glove for gesture identification, comprising a plurality of finger sleeves for encasing user's fingers, each of the finger sleeves comprising a plurality of sleeve sections, and each of the sleeve sections having at least one finger identification symbol disposed thereon; and a glove body for encasing user's palm, the glove body being attached to the finger sleeves, and having at least one hand identification symbol disposed thereon. With the arrangement of the finger identification symbols and the hand identification symbols, it assists to assure gesture identification to identify the palm side and the back side of the user's hand and the fingers and gestures more accurately and efficiently while the user wears the glove in this invention, and so as to simplify the processing process and improve the accuracy of gesture identification. In additional, the glove in this invention is made by a common glove, thus it is easy to wear.

### BACKGROUND OF THE INVENTION

### 1. Field of the Invention

This invention relates to a gesture identification device, particularly a glove for gesture identification.

### 2. The Related Art

The present application is based on, and claims priority from, Chinese application number 2017111288694, filed Nov. 15, 2017, the disclosure of which is hereby incorporated by reference herein in its entirety.

With the develop of technology, human-computer interaction interface had become an important part in daily life. Conventional interface that interacts with physical methods such as keyboard and mouse can't satisfied people's requirements completely, hence new solutions such as gesture recognition, speech recognition and human face identify had become popular research subjects nowadays. In comparison with traditional interface, gesture recognition is a more nature and intuitive way to interact with computer, and having a wider application prospect in the field of intelligent systems, robot control, multimedia teaching, entertainment games and the like.

The existing gesture recognition methods can be divided into three categories according to the recognition ways and principles: inertial sensing, optical sensing, and the mix sensing. The specific application comprises the following methods:

1, equipping a related hardware device such as a G-sensor on human's hand, and obtain the information of the human hand such as position and speed through a calculation module within the hardware device, in this mode, the positioning and the tracking in the recognition process can be well guided and guarantee.

2, capturing an image of human hand with a camera, and process the image with a background software, the position of the hand is then be measured by comparing the contrast information of different parts of the hand image.

However, the first method requires the user to put on an expensive device before the device identifies the gesture every time, and the second method needs a high-resolution camera, besides the processing process of the gesture recognition device is complicate, so the result of gesture recognition is inconsistent.

Therefore, it is necessary to provide a glove for emphasizing gesture which satisfies requirements of easy to wear, simple processing process and accurate recognition result to meet the user's demand.

### SUMMARY OF THE INVENTION

The objective of the present invention is to provide a glove for gesture identification which is easy to use, capable to improve the accuracy of gesture identification and simplify the processing process of the gesture identification.

To achieve said objective, the present invention provides a glove for gesture identification, comprising a plurality of finger sleeves for encasing user's fingers, each of the finger sleeves comprising a plurality of sleeve sections, and each of the sleeve sections having at least one finger identification symbol disposed thereon; and a glove body for encasing user's palm, the glove body being attached to the finger sleeves, and having at least one hand identification symbol disposed thereon.

In a preferred embodiment, the glove body comprises a palm section with a hand identification symbol.

In a preferred embodiment, the glove body comprises a back section with a hand identification symbol.

In a preferred embodiment, the glove body comprises a palm section with a hand identification symbol, and a back section with another hand identification symbol, the hand identification symbols arranged on the palm section and back section being recognizable with each other.

In a preferred embodiment, the glove is a left-hand glove and the glove body of the left-hand glove comprises at least one left-hand identification symbol.

In a preferred embodiment, the glove is a right-hand glove and the glove body of the right-hand glove comprises at least one right-hand identification symbol.

In a preferred embodiment, the finger identification symbols being arranged on a palm side and a back side of the sleeve sections.

In a preferred embodiment, each of the finger identification symbols is arranged to different shape.

In a preferred embodiment, each of the finger identification symbols is arranged to different color.

In a preferred embodiment, the color of the finger identification symbols and the hand identification symbols are different with the color of the glove.

In conclusion, the glove for gesture identification in this embodiment comprises a plurality of finger sleeves each comprising at least one finger identification symbol that associated with a finger section and a glove body comprising at least one hand identification symbol that associated with the palm. With the arrangement of said finger identification symbols and hand identification symbols, it assists to assuring the gesture identify system to identify the palm side and the back side of the user's hand and the fingers and gestures more accurately and efficiently while the user wears the glove in this invention, and so as to simplify the processing process and improve the accuracy of identification. In additional, the glove in this invention is a common glove, thus it is easy to wear.

### BRIEF DESCRIPTION OF THE DRAWINGS

The present invention will be apparent to those skilled in the art by reading the following description, with reference to the attached drawings, in which:

FIG. 1 is a schematic diagram showing a left-hand glove with its palm side up;

FIG. 2 is a schematic diagram showing the left-hand glove with its back side up;

FIG. 3 is a schematic diagram showing a right-hang glove with its palm side up;

FIG. 4 is a schematic diagram showing the right-hand glove with its back side up;

### DETAILED DESCRIPTION OF THE PREFERRED EMBODIMENT

In order to describe the technical contents, structural features, purpose to be achieved and the effectiveness of the present invention, the detailed description is given with schema below.

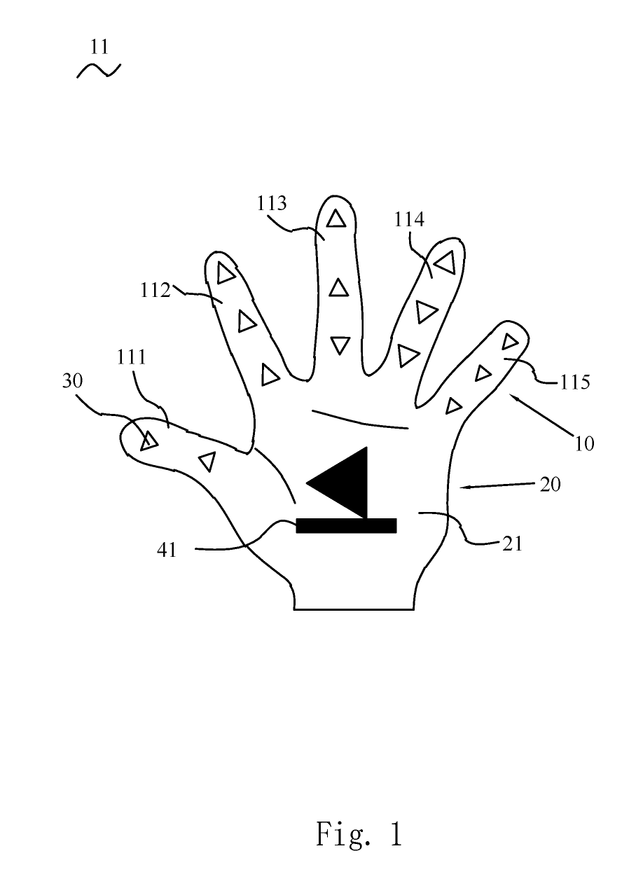

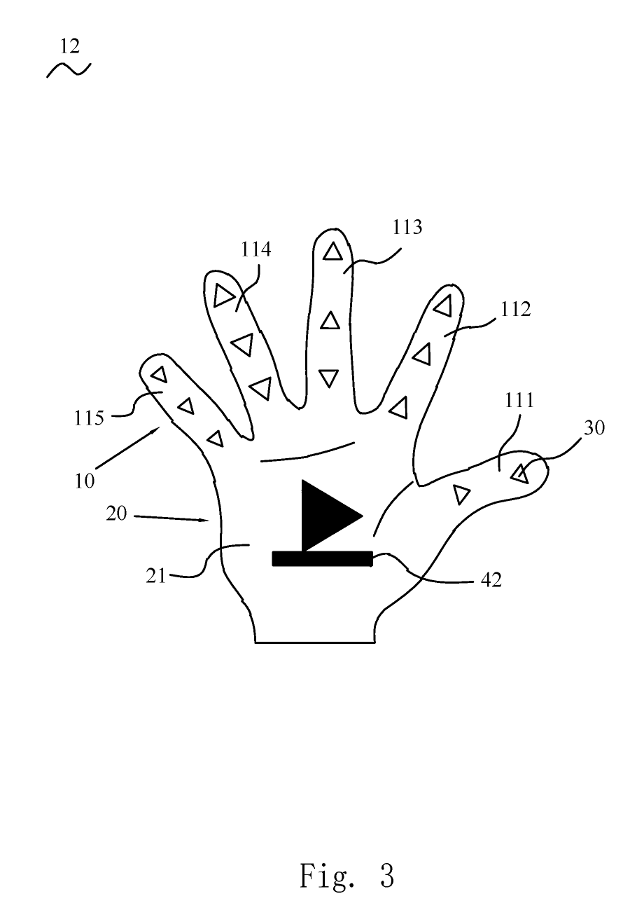

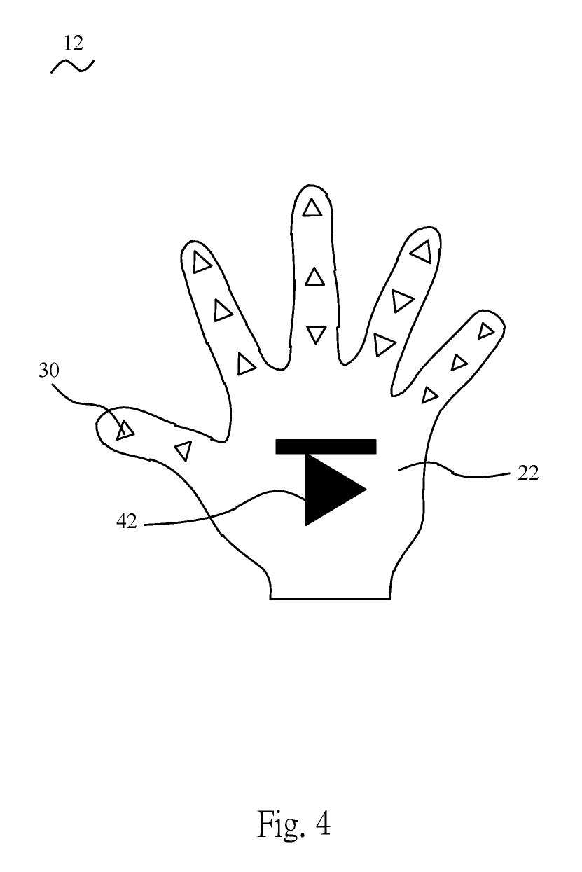

Referring to FIG. 1 to FIG. 4 now, a glove for gesture identification comprises a glove body 20 and a plurality of finger sleeves 10 which are attached to said glove body 20. The finger sleeves 10 comprises a plurality finger identification symbols 30 and each of the finger identification symbols 30 is associated with a different finger section. The glove body 20 also comprises at least one hand identification symbol 41, 42. In the embodiment shown in this diagram, the glove comprises a left-hand glove 11 and a right-hand glove 12 and each of left-hand and right-hand glove 11, 12 is arranged with a hand identification symbol 41, 42. The hand identification symbol 41 of the left-hand glove 11 is different to the hand identification symbol 42 of the right-hand glove 12. The color of the finger identification symbols 30 and the hand identification symbols 41, 42 are different to the color of the gloves 11, 12 itself. The finger identification symbols 30 and the hand identification symbols 41, 42 are made by at least one of printing, weaving, fluorescent coating and luminescent material.

Referring to FIG. 1 to FIG. 4 now, a human hand can be divided into five fingers and a palm, and each of the fingers comprises a base-section which attaches to the palm, a mid-section which attaches to the base-section (except the thumb which only comprises two finger sections), and a tip-section which attaches to the mid-section (the tip-section of the thumb connects to the base-section directly).

The glove body 20 further comprises a palm section 21 encasing the palm of the human hand and a back section 22 encasing a back of the palm of the human hand. In this embodiment, the palm identification symbols 41, 42 are disposed on the palm section 21 and the back section 22 respectively. The palm identification symbols 41, 42 disposed on the palm section 21 and back section 22 are different in color or shape, thus it would be easy to identify the palm of the hand with the back of the hand.

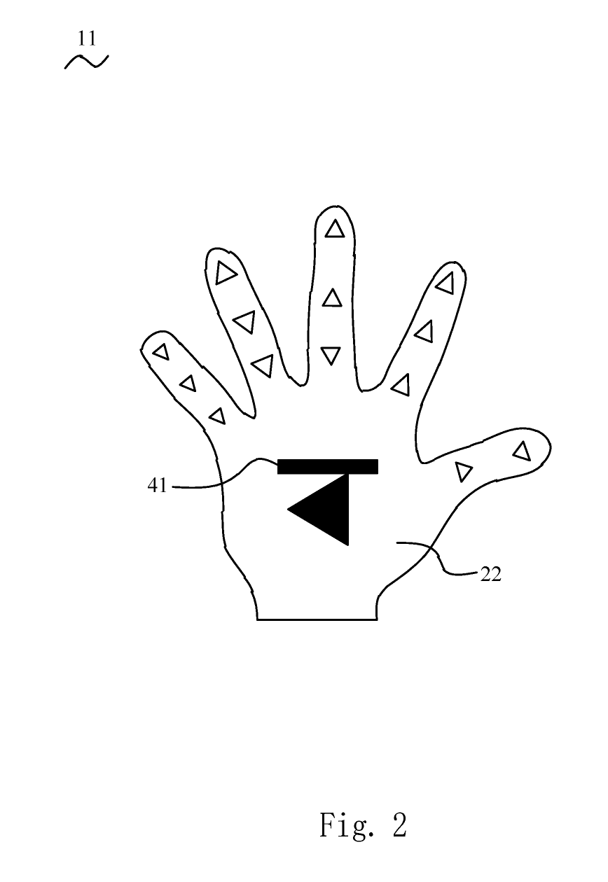

Referring to FIG. 1 and FIG. 2 now, in this embodiment, the finger identification symbols 30 are disposed on a palm side and a back side of each of the finger sleeves 10, but in another embodiment, the finger identification symbols 30 can only be disposed on one side of the finger sleeves 10. In this embodiment, each of the finger sleeves 10 can be divided into three sleeve sections, each of the sleeve sections is associated with one of the following finger sections: the tip-section, the mid-section and the base-section (except the finger sleeve of thumb which only comprises two sections: the tip-section and the base-section) and the finger identification symbols 30 are disposed on both the palm side and the back side of the sleeve sections. The finger identification symbols 30 disposed on different finger sleeves 10 are different with each other in its color or shape, and each of the finger sections of the finger sleeves 10 has at least one the finger identification symbol 30, thus it would be easy to identify each of the finger sleeves 10 and finger sections with different color combinations or shape combinations of the finger identification symbols 30.

Referring to FIG. 1 to FIG. 4 now, each of the left-hand glove 11 and the right-hand glove 12 in this embodiment comprises five finger sleeves 10 which encasesfingers of human hand respectively. Each of the left-hand glove 11 and the right-hand glove 12 includes a first finger portion 111 encasing the thumb, a second finger portion 112 encasing the index finger, a third finger portion 113 encasing the middle finger, a fourth finger portion 114 encasing the ring finger, and a fifth finger portion 115 encasing the little finger.

Referring to FIG. 1 and FIG. 2 now, a left-palm identification symbol is defined as the hand identification symbol 41 disposed on the palm section 21 of the left-hand glove 11, the left-palm identification symbol comprises an isosceles triangle and a rectangle. The vertex of the isosceles triangle of left-palm identification symbol points to the first finger sleeve 111 and the longer edge of the rectangle of left-palm identification symbol is parallel to the midline of the isosceles triangle of left-palm identification symbol. The rectangle of left-palm identification symbol is disposed below the isosceles triangle of left-palm identification symbol and connected to the isosceles triangle of left-palm identification symbol. A left-back identification symbol is defined as the hand identification symbol 41 disposed on the back section 22 of the left-hand glove 11, the left-back identification symbol comprises an isosceles triangle and a rectangle. A vertex of the isosceles triangle of the left-back identification symbol points to the opposite direction of the first finger sleeve 111 of the left-hand glove 11 and the longer edge of the rectangle of the left-back identification symbol is parallel to the midline of the isosceles triangle of the left-back identification symbol. Thus, it doesn't matter whether the palm section 21 or the back section 22 of the left-hand glove 11 faces a user (which means no matter the left-hand glove 11 being placed front side or back side up), the vertexes of the left-palm identification symbol and the left-back identification symbol are always pointed to the same direction (the left side of the user's left hand).

Referring to FIGS. 1, 3 and 4 now, A right-palm identification symbol is defined as the hand identification symbol 42 disposed on the palm section 21 of the right-hand glove 12 and A right-back identification symbol is defined as the hand identification symbol 42 disposed on the back section 22 of the right-hand glove 12. The right-palm identification symbol and the right-back identification symbol are similar to the left-palm identification symbol and the left-back identification symbol, the only difference is that vertexes of the left-palm identification symbol and the left-back identification symbol are pointing to the left side of the user's left hand, but the vertexes of the right-palm identification symbol and the right-back identification symbol are pointing to the right side of the user's right hand. Thus, it doesn't matter whether the palm section 21 or the back section 22 of the right-hand glove 12 faces the user, which means no matter the right-hand glove 12 being placed front side or back side up, the vertexes of right-palm identification symbol and the right-back identification symbol always point to the right side of user's right hand.

Referring to FIG. 1 to FIG. 4 now, each of the finger sleeves 10 comprises a fixed end attaching to the glove body 20 and a free end which is opposite to the fixed end.

Each of the finger identification symbols 30 disposed on the palm side and the back side of the base section of the first finger sleeve 111 is an isosceles triangle with a vertex pointing to the free end. Each of the finger identification symbols 30 disposed on the palm side and the back side of the tip-section of the first finger sleeve 111 is an isosceles triangle with a vertex pointing to the fixed end. Each of the finger identification symbols 30 disposed on the palm side and the back side of the tip-section, the mid-section and the base-section of the second finger sleeve 112 is an isosceles triangle with a vertex pointing to the free end. Each of the finger identification symbols 30 disposed on the palm side and the back side of the mid-section and the tip-section of the third finger sleeve 113 is an isosceles triangle with a vertex pointing to the free end. Each of the finger identification symbols 30 disposed on the palm side and the back side of the base-section of the third finger sleeve 113 is an isosceles triangle with a vertex pointing to the fixed end. Each of the finger identification symbols 30 disposed on the palm side and the back side of the base-section and the mid-section of the fourth finger sleeve 114 is an isosceles triangle with a vertex pointing to the fixed end. Each of the finger identification symbols 30 disposed on the palm side and the back side of the tip-section of the fourth finger sleeve 114 is an isosceles triangle with a vertex pointing to the free end. Each of the finger identification symbols 30 disposed on the palm side and the back side of the base-section, the mid-section and the tip-section of the fifth finger sleeve 115 is an isosceles triangle with a vertex pointing to the fixed end.

The isosceles triangles disposed on each the finger sleeves 10 are pointing to different direction, so as to assure the gesture identification be able to identify fingers and gestures of the user easily.

In conclusion, the glove for gesture identification in this embodiment comprises a plurality of finger sleeves 10, each of the finger sleeves 10 comprises at least one the finger identification symbol 30, each of the finger identification symbol 30 associates with each of the base-section, the mid-section and the tip-section. The glove body 20 comprises two the hand identification symbols 41, 42. Each of the hand identification symbols 41, 42 associates with each of the palm section and the back section. With the arrangement of the finger identification symbols 30 and the hand identification symbols 41, 42, it assists to assure gesture identification to identify the palm side and the back side of the user's hand and the fingers and gestures more accurately and efficiently while the user wears the glove in this invention, and so as to simplify the processing process and improve the accuracy of gesture identification. In additional, the glove in this invention is made by a common glove, thus it is easy to wear.

What is claimed is:

1. A glove for gesture identification, comprising
a plurality of finger sleeves for encasing user's fingers, each of the finger sleeves comprising a plurality of sleeve sections, and each of the sleeve sections having at least one finger identification symbol disposed thereon; and
a glove body for encasing user's palm, the glove body being attached to the finger sleeves, and having at least one hand identification symbol disposed thereon.

2. The glove for gesture identification as claimed in claim 1, wherein the glove body comprises a palm section with a hand identification symbol.

3. The glove for gesture identification as claimed in claim 1, wherein the glove body comprises a back section with a hand identification symbol.

4. The glove for gesture identification as claimed in claim 1, wherein the glove body comprises a palm section with a hand identification symbol, and a back section with another hand identification symbol, the hand identification symbols arranged on the palm section and back section being recognizable with each other.

5. The glove for gesture identification as claimed in claim 1, wherein the glove is a left-hand glove and the glove body of the left-hand glove comprises at least one left-hand identification symbol.

6. The glove for gesture identification as claimed in claim 1, wherein the glove is a right-hand glove and the glove body of the right-hand glove comprises at least one right-hand identification symbol.

7. The glove for gesture identification as claimed in claim 1, wherein the finger identification symbols being arranged on a palm side and a back side of the sleeve sections.

8. The glove for gesture identification as claimed in claim 1, wherein each of the finger identification symbols is arranged to different shape.

9. The glove for gesture identification as claimed in claim 7, wherein each of the finger identification symbols is arranged to different shape.

10. The glove for gesture identification as claimed in claim 1, wherein each of the finger identification symbols is arranged to different color.

11. The glove for gesture identification as claimed in claim 7, wherein each of the finger identification symbols is arranged to different color.

12. The glove for gesture identification as claimed in claim 1, wherein the color of the finger identification symbols and the hand identification symbols are different with the color of the glove.
